(19) United States
(12) Patent Application Publication
(10) Pub. No.: US 2006/0258281 A1
(43) Pub. Date: Nov. 16, 2006

(54) Air duct with annular rolling portion

(76) Inventor: Arthur B. Cripps JR., Murray, KY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/127,332

(22) Filed: May 12, 2005

(51) Int. Cl. B60H 1/26

(52) U.S. Cl. 454/137

(57) ABSTRACT

An air duct is constructed with a rolling annular portion that is desirably formed of a series of hemi-toroid planar-cut surfaces. The rolling annular portion may include an inner portion and an outer portion constructed of different materials. The rolling annular portion permits relative movement within the air duct while minimizing disturbances in airflow.

### TECHNICAL FIELD

The present invention relates to air ducts interconnecting components that may experience relative movement and in particular to air ducts with improved airflow characteristics.

### BACKGROUND OF THE INVENTION

Air ducts are provided in internal combustion engine applications as a means to channel airflow from one component to another. A typical application is an elongated air duct that channels filtered air from the outlet of an air filter housing to the engine intake. To prevent the introduction of contamination into the engine, the air duct is sealed to both the air filter housing and the engine intake. Often, the engine air filter housing is not mounted directly to the engine and, therefore, the air filter housing and the engine experience relative movement therebetween during engine operation. To accommodate this relative movement without compromising the air duct seals, the air may incorporate a flexible region, as described below.

Referring to FIGS. 1-3, a prior art air duct 20 is illustrated. Air duct 20 includes an elongate hollow body 22 defined by an inlet opening 24, an outlet opening 26, and a undulating region 28. The undulating region 28 is located within body 22 and includes hemi-toroid portions 30 extending therefrom. As illustrated, inlet opening 24 is larger than outlet opening 26.

As best seen in FIG. 2, hemi-toroid portions 30 are typically defined by an inside surface 32 and an outside surface 34. Each of the inside surface 32 and the outside surface 34 define a shape that closely resembles a series of concave and convex surfaces. Hemi-toroid portions 30 are hemi-toroid in shape with each hemi-toroid portion 30 sectioned from a true torus by a cylindrical cut.

Undulating region 28, if not all of air duct 20, is typically constructed of a flexible material. Undulating region 28 provides a desired amount of flexibility within air duct 20 to allow inlet opening 24 and outlet opening 26 to move independently. Generally, undulating region 28 permits about 2 inches of relative movement between inlet opening 24 and outlet opening 26. Also, undulating region 28 allows installation of air duct 20 after the air filter housing and engine intake are secured, and accommodates a limited amount of mis-alignment.

FIG. 3 illustrates relative positions of air duct 20 in section as undulating region 28 accommodates relative movement between inlet opening 24 and outlet opening 26. As outlet opening 26 is deflected to the position of outlet opening 26′, elongate body 22 is distorted to the outline 22′ and undulating region 28 is distorted to the outline 28′. This distortion within air duct 20 causes airflow A to be deflected as generally represented by a non-linear path N.

One disadvantage of the undulating region 28 is that as the air duct 20 accommodates relative movement between inlet opening 24 and outlet opening 26, the elongate body 22 is distorted such that air flow A through air duct 20 follows the non-linear path N (FIG. 3). This non-linear path N restricts the airflow A within air duct 20.

Another disadvantage of an undulating region 28 is the undesirable disturbance in airflow A (FIG. 2) through air duct 20. As air flows through air duct 20 from inlet opening 24 to outlet opening 26, a smooth, laminar airflow is desired through air duct 20. However, undulating region 28 introduces a turbulent air flow T. Turbulent airflow T is partly due to the non-uniform inside surface 32 and the pressure drop within air duct 20 associated with the increase in area provided by undulating region 28. What is needed, therefore, is an air duct with a flexible region that will desirably accommodate relative movement between the openings of an air duct, while minimizing any disturbances in air flow.

### SUMMARY OF THE INVENTION

An embodiment of the present invention provides an air duct having an elongate body that includes a first opening, a second opening and a displacement portion. The displacement portion selectively accommodates an axial displacement within the elongate body between the first opening and the second opening. The displacement portion includes a rolling annular portion. The elongate body is adapted to minimize disturbances in airflow.

Another embodiment of the present invention provides a rolling annular portion for an air duct. The rolling annular portion includes an inner portion having an outer periphery and an outer portion. The outer portion is positioned about at least a portion of the outer periphery of the inner portion. The outer portion and the inner portion are formed of different materials. At least a portion of the outer periphery is selectively formed into at least one planar-cut hemi-toroid surface.

Yet another embodiment of the present invention provides a method of manufacturing an air duct. The method includes forming a first material in a mold to produce a first portion of the air duct, and forming a rolling annular portion in a desired region of the air duct. The rolling annular portion is selectively adapted to minimize disturbances in airflow.

### BRIEF DESCRIPTION OF THE DRAWINGS

The present invention will now be described, by way of example, with reference to the accompanying drawings, in which:

FIG. 1 is a perspective view of a prior art air duct.

FIG. 2 is a partial sectional view of the air duct of FIG. 1.

FIG. 3 is a sectional view of the prior art air duct of FIG. 1, illustrated in a distorted shape.

FIG. 4 is a perspective view of an air duct in accordance with an embodiment of the present invention.

FIG. 5 is a partial sectional view of the air duct of FIG. 4.

FIG. 6 is similar to FIG. 5, showing the air duct in an extended position.

FIG. 7 is similar to FIG. 5, showing the air duct in a retracted position.

FIG. 8 is a flowchart illustrating an embodiment of a method for producing an air duct in accordance with the present invention.

### DETAILED DESCRIPTION

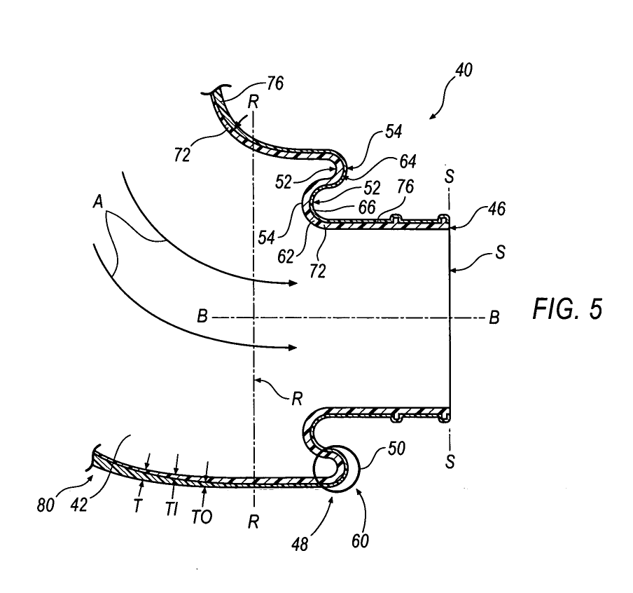

Referring to FIGS. 4 and 5, an embodiment of an air duct 40 is illustrated. Air duct 40 includes an elongate hollow body 42 defining an inlet opening 44, an outlet opening 46, and an undulating region 48. Undulating region 48 is located within body 42 and includes hemi-toroid portions 50 formed therein. Each hemi-toroid portion 50 includes a concave surface 52 and a convex surface 54. Air duct 40 has a generally constant wall thickness T throughout. Stiffening members 56 are attached to body 42 in desired regions.

Hemi-toroid portions 50 are curved, annular regions of air duct 40 with each hemi-toroid portion 50 sectioned from a hollow torus (not shown) by a plane that, in the embodiment shown, bisects the torus. Thus, hemi-toroid portions 50 can also be referred to as planar-cut hemi-toroid portions 50.

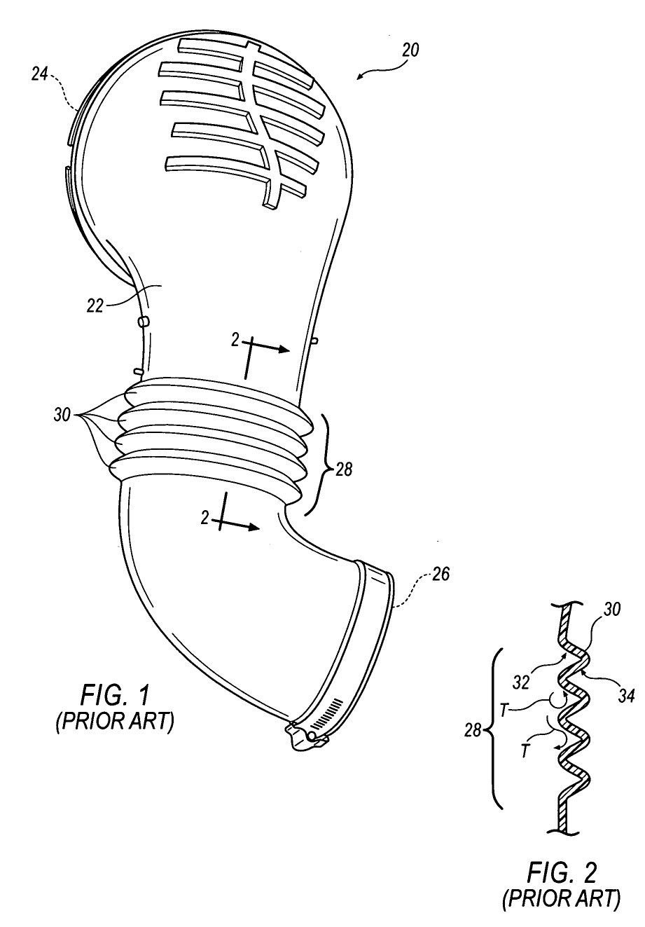

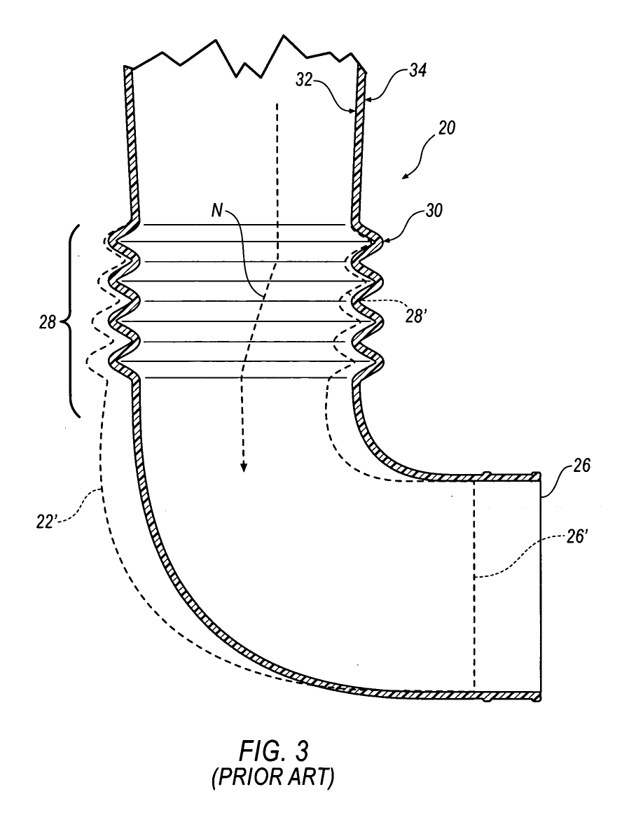

As best illustrated in FIG. 5, undulating region 48 includes a series of hemi-toroid portions 50 whose concave surfaces 52 face opposing directions, and form opposing planar-cut hemi-toroid surfaces. In contrast, FIGS. 1-3 illustrate that prior art undulating region 28 includes a series of hemi-toroid portions 30 whose concave surfaces face opposing directions, yet this configuration forms opposing cylindrical-cut hemi-toroid surfaces.

With reference to FIGS. 5-7, outlet opening 46 generally defines a plane S, indicated by line S-S. A plane R intersects elongate body 42 in the same location of air duct 40 in each of FIGS. 5-7. Outlet opening 46 also has an axis B-B that is generally normal to plane S. In the configuration illustrated in FIG. 5 axis B-B is normal to plane R. Airflow A travels generally parallel to axis B-B when exiting outlet opening 46. Generally, the region of air duct 40 that is located between planes R and S is a flexible portion 60.

Air duct 40 has an inner portion 62 having an outer periphery 64, and an outer portion 66. Inner portion 62 is constructed of at least a first material 72 and outer portion 66 is constructed of at least a second material 76. Stiffening members 56 are also constructed of the second material 76. Preferably, the outer portion 66 completely encases the outer periphery 64. Also preferably, first material 72 is more flexible than second material 76, as discussed in greater detail below. The region of air duct 40 exclusive of the flexible portion 60 is rigid portion 80. Inner portion 62 has a thickness TI that varies within air duct 40, and outer portion 66 has a thickness TO that varies within air duct 40, as discussed in greater detail below.

Thickness TI of inner portion 62 is preferably greater than thickness TO of outer portion 66 within flexible portion 60. Thickness TO of outer portion 66 is preferably greater than thickness TI of inner portion 62 within rigid portion 80. In the embodiment illustrated, thickness TI is about 90% of thickness T within most of the flexible portion 60 and thickness TO is about 90% of thickness T within most of the rigid portion 80. Since the first material 72 is more flexible than the second material 76, the flexible portion 60 is more flexible than the rigid portion 80.

Thicknesses TI and TO vary in the region adjacent plane R as indicated by outer periphery 64 in FIGS. 5-7. While this variance in thicknesses has been illustrated in one possible configuration in FIGS. 5-7, the transition between flexible portion 60 and rigid portion 80 may be a gradual transition in thicknesses, or an abrupt change in thicknesses.

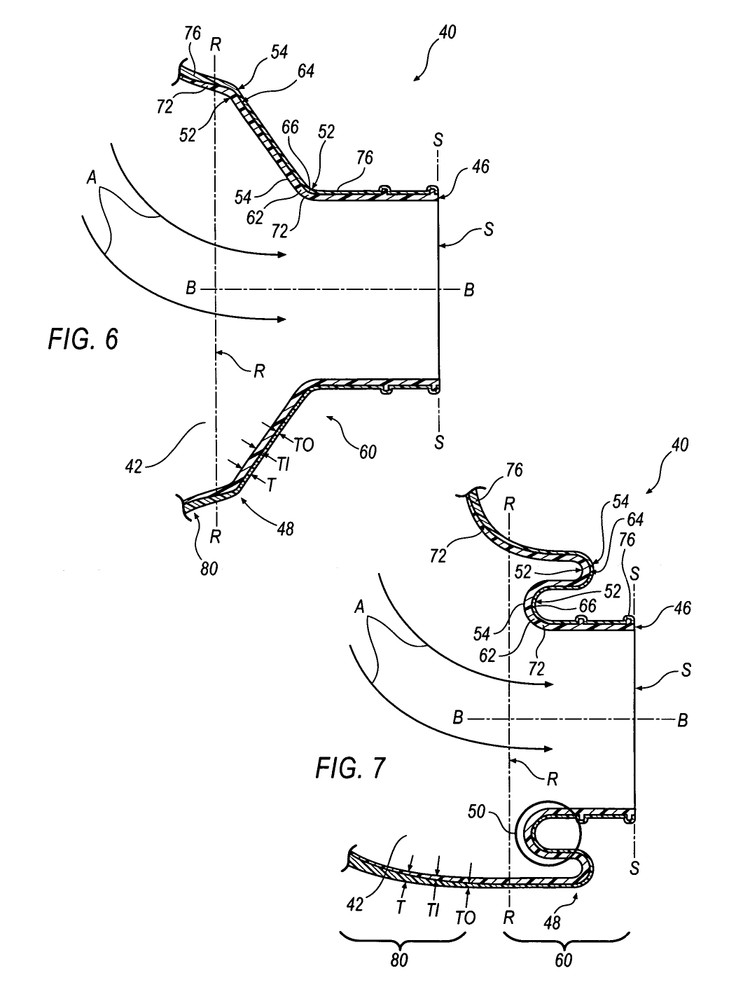

Flexible portion 60 is moveable between an extended position (FIG. 6), and a retracted position (FIG. 7). Preferably, the distance between planes R and S in FIG. 6 is more than 2 inches greater than the distance between planes R and S in FIG.7.

As best seen in FIGS. 5-7, flexible portion 60 can accommodate some amount of angular misalignment between axis B-B and a line normal to plane R. Additionally, flexible portion 60 can accommodate some amount of displacement between axis B-B and a line normal to plane R.

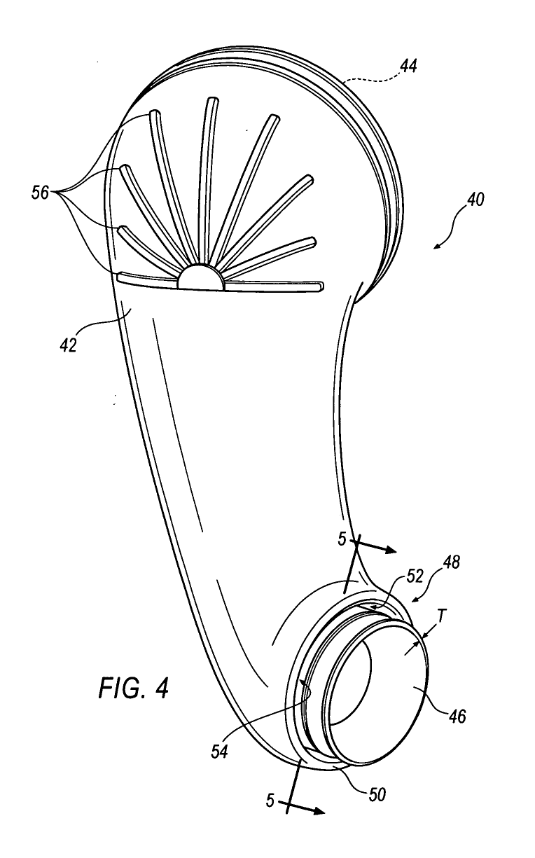

Rigid portion 80 resists distortion as flexible portion 60 accommodates displacement and/or rotation between inlet opening 44 and outlet opening 46. While some distortion within rigid portion 80 may occur as flexible portion 60 accommodates displacement and/or rotation between inlet opening 44 and outlet opening 46, the airflow characteristics of air duct 40 remain relatively unchanged. As discussed earlier, the prior art undulating region 28 may result in undesirable levels of distortion in air duct 20 that causes degradation of airflow characteristics (FIG. 3).

Preferably, flexible portion 60 does not elastically expand, but rather the hemi-toroid portions 50 roll as best seen when contrasting the relative positions of planes R and S in FIGS. 5-7. Therefore, undulating region 48 is referred to as a rolling annular portion. FIG. 5 generally depicts undulating region 48 in a preferred as-formed state.

Flexible portion 60 is defined by planar-cut hemi-toroid surfaces at least during portions of the axial displacement of outlet opening 46, as represented in FIGS. 5 and 7. However, flexible portion 60 is not defined by planar-cut hemi-toroid surfaces when in the extended position of FIG. 6.

Preferably, the first material 72 is Santoprene™ or other relatively flexible thermoplastics with favorable blow-molding characteristics. Also preferably, the second material 76 is polypropylene, or other relatively rigid thermoplastics with favorable blow-molding characteristics. While undulating region 48 has been described as including two planar-cut hemi-toroid portions 50, undulating region 48 may include any number of planar-cut hemi-toroid portions 50, or may include portions that deviate from an exact hemi-toroid shape.

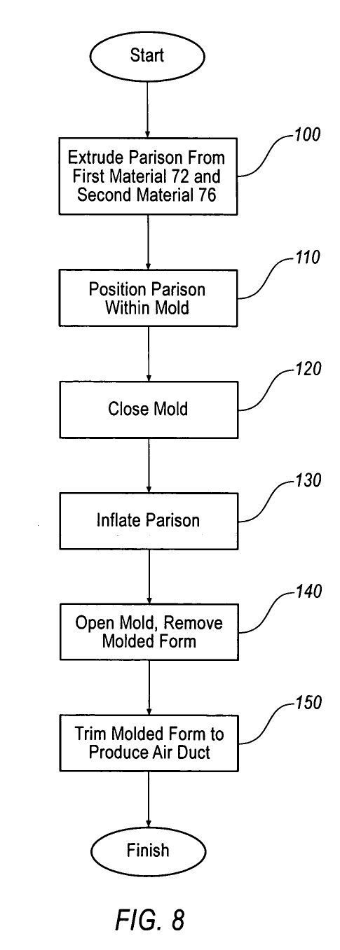

FIG. 8 illustrates one embodiment of manufacturing the air duct 40 using extrusion blow molding. In step 100, the first material 72 and the second material 76 are co-extruded to form a parison (not shown). Thus formed, the parison is a generally hollow cylinder formed with the first material positioned within the second material 76. The parison extrudes with a calibrated measure of pre-blow to prevent collapse.

In step 110, the parison is positioned within a mold. In step 120, the mold is closed, pinching the axial end of the parison that is opposite the axial end connected to the blowing apparatus. In step 130, air or other gas is introduced through the blowing apparatus and into the parison, inflating the parison to expand until the parison contacts the interior surfaces of the mold. In step 140, the mold is opened, and the molded form is removed. In step 100, the molded form is trimmed to produce an air duct 40. The mold includes mold portions that are defined, at least in part, by the interior surfaces of the mold and a mold portion interface. Each mold portion interface includes at least one generally planar mold interface surface. The mold interface surfaces are in contact when the mold is closed.

Preferably, the air duct 40 is interposed between a primary air filter housing (not shown) and an engine air intake. Even more preferably, the air duct 40 is interposed between a primary air filter housing (not shown) and a turbo charger air intake.

While the invention has been described with respect to specific examples including preferred modes of carrying out the invention, those skilled in the art will appreciate that there are numerous variations and permutations of the above described systems and techniques that fall within the spirit and scope of the invention as set forth in the appended claims.

What is claimed is:

1. An air duct comprising:
an elongate body having a first opening, a second opening and a displacement portion,
wherein said displacement portion selectively accommodates at least an axial displacement within said elongate body, said displacement portion includes a rolling annular portion adjacent to one of said first and second openings, and at least a central region of said elongate body is adapted to minimize disturbances in airflow.

2. The air duct of claim 1, wherein said rolling annular portion comprises a first substantially planar-cut hemi-toroid surface during at least a portion of said axial displacement.

3. The air duct of claim 2, wherein said rolling annular portion further comprises a second substantially planar-cut hemi-toroid surfaces during at least a portion of said axial displacement.

4. The air duct of claim 1, wherein said rolling annular portion is more flexible than said central region.

5. The air duct of claim 1, wherein said air duct is constructed of a first portion formed of a first material, and a second portion formed of a second material.

6. The air duct of claim 5, wherein said first portion comprises an inner portion of said air duct.

7. The air duct of claim 5, wherein said first material is more flexible than said second material.

8. The air duct of claim 7, wherein said first portion is thicker than said second portion in said rolling annular portion.

9. The air duct of claim 7, wherein said second portion is thicker than said first portion in said central region.

10. The air duct of claim 5, wherein said first material is Santoprene™.

11. The air duct of claim 5, wherein said second material is polypropylene.

12. The air duct of claim 1, wherein said first portion and said second portion are extrusion blow molded to form said air duct.

13. The air duct of claim 1, further comprising stiffening members attached to said elongate body.

14. A rolling annular portion for an air duct, comprising:
an inner portion having an outer periphery; and
an outer portion positioned about at least a portion of said outer periphery of said inner portion, wherein said outer portion and said inner portion are formed of different materials; and at least a portion of said outer periphery is selectively formed into at least one substantially planar-cut hemi-toroid surface.

15. The air duct of claim 14, wherein one of said outer portion and said inner portion comprise a flexible material.

16. The air duct of claim 15, wherein said flexible material is Santoprene™.

17. The air duct of claim 14, wherein said outer portion and said inner portion are formed by extrusion blow molding.

18. The air duct of claim 14, wherein said outer periphery is defined by a plurality of substantially planar-cut hemi-toroid surfaces during operation of the air duct.

19. A method of manufacturing an air duct comprising the steps of:
forming a first material in a mold to produce a first portion of said air duct; and
forming a rolling annular portion in a desired region of said air duct, wherein said rolling annular portion is selectively adapted to minimize disturbances in airflow, wherein at least a portion of said rolling annular portion is selectively defined by at least one substantially planar-cut hemi-toroid surface.

20. The method of claim 19, further comprising the step of forming a second material in said mold to produce a second portion of said air duct.

21. The method of claim 20, wherein preselected portions of the steps of forming are completed simultaneously.
